(19) United States
(12) Patent Application Publication
(10) Pub. No.: US 2016/0373177 A1
(43) Pub. Date: Dec. 22, 2016

(54) BASE STATION, COMMUNICATION CONTROL METHOD, AND PROCESSOR

(71) Applicant: KYOCERA CORPORATION, Kyoto (JP)

(72) Inventors: Atsuhisa INAKOSHI, Kawasaki-shi (JP); Kugo MORITA, Yokohama-shi (JP); Masato FUJISHIRO, Yokohama-shi (JP); Chiharu YAMAZAKI, Ota-ku (JP); Naohisa MATSUMOTO, Kawasaki-shi (JP)

(73) Assignee: KYOCERA CORPORATION, Kyoto (JP)

(21) Appl. No.: 14/901,475

(22) PCT Filed: Jun. 24, 2014
(86) PCT No.: PCT/JP2014/066707

§ 371 Date: Dec. 28, 2015

(30) Foreign Application Priority Data
Jun. 26, 2013 (JP) 2013-134378

(51) Int. Cl. H04B 7/06; H04B 7/02; H04W 16/28; H04W 72/10

(52) U.S. Cl. CPC H04B 7/0617; H04W 72/10; H04B 7/024; H04W 16/28

(57) ABSTRACT

eNB 200-2 receives beamforming control information fed back from each of a plurality of UEs 100-2 that are connected with the eNB 200-2, and null-steering control information fed back from UE 100-1. The eNB 200-2 calculates, for each of the plurality of UEs 100-2, assignment priority by which to assign the same radio resource as a radio resource assigned to the UE 100-1, on the basis of reference priority derived from a scheduling algorithm, and matching degree between the null-steering control information and the beamforming control information. The eNB 200-2 assigns the same radio resource to a UE 100-2 having the highest assignment priority, from among the plurality of UEs 100-2.

### TECHNICAL FIELD

The present invention relates to a base station used in a mobile communication system that supports downlink multi-antenna transmission, a communication control method therefor, and a processor therefor.

### BACKGROUND ART

An LTE system of which the specifications are formulated in 3GPP (3rd Generation Partnership Project), which is a project aiming to standardize a mobile communication system, supports downlink multi-antenna transmission (see Non Patent Literature 1). For example, a base station included in a radio access network performs beamforming that directs a beam to one user terminal and performs null steering that directs a null to another user terminal. In this way, it is possible to improve usage efficiency of radio resources while suppressing interference.

As an example of the downlink multi-antenna transmission, there is CB (Coordinated Beamforming)-CoMP (Coordinated Multi Point). In the CB-CoMP, a base station that manages a cell receives beamforming control information transmitted from each of a plurality of terminals subject to beamforming connected with the cell of the base station, and null-steering control information transmitted from a terminal subject to null steering connected with a neighboring cell.

Then, the base station selects, as a pair terminal that forms a pair with the terminal subject to null steering, a terminal subject to beamforming that transmits the beamforming control information that matches the null-steering control information. Further, the base station assigns the same radio resource as a radio resource assigned to the terminal subject to null steering to the pair terminal.

### CITATION LIST

### Non Patent Literature

[NPL 1] 3GPP Technical Specification “TS 36.300 V11.5.0” March, 2013

### SUMMARY OF INVENTION

However, when there is no terminal subject to beamforming that feeds back beamforming control information that matches null-steering control information, a base station is not capable of appropriately selecting a pair terminal.

In this case, it may be possible that a radio resource assigned to a terminal subject to null steering is not used or a pair terminal is randomly selected. However, there is a problem that in the former case, usage efficiency of the radio resource is decreased, and in the latter case, interference to the terminal subject to null steering is increased.

Therefore, an object of the present invention is to provide a base station capable of appropriately selecting a pair terminal that forms a pair with a terminal subject to null steering, from among a plurality of terminals subject to beamforming, a communication control method therefor, and a processor therefor.

A base station according to a first aspect manages a cell in a mobile communication system supporting downlink multi-antenna transmission. The base station comprises a receiver configured to receive beamforming control information fed back from each of a plurality of terminals that are subject to beamforming and that are connected with the cell, and null-steering control information fed back from a terminal subject to null steering; and a controller configured to calculate, for each of the plurality of terminals subject to beamforming, assignment priority by which to assign the same radio resource as a radio resource assigned to the terminal subject to null steering, on the basis of reference priority derived from a scheduling algorithm, and matching degree between the null-steering control information and the beamforming control information. The controller assigns the same radio resource to a terminal subject to beamforming having the highest assignment priority, from among the plurality of terminals subject to beamforming.

A communication control method according to a second aspect is used in a mobile communication system supporting downlink multi-antenna transmission. The communication control method comprises the steps of: receiving, by a base station managing a cell, beamforming control information fed back from each of a plurality of terminals that are subject to beamforming and that are connected with the cell, and null-steering control information fed back from a terminal subject to null steering; calculating, by the base station, for each of the plurality of terminals subject to beamforming, assignment priority by which to assign the same radio resource as a radio resource assigned to the terminal subject to null steering, on the basis of reference priority derived from a scheduling algorithm, and matching degree between the null-steering control information and the beamforming control information; and assigning, by the base station, the same radio resource to a terminal subject to beamforming having the highest assignment priority, from among the plurality of terminals subject to beamforming.

A processor according to a third aspect is provided in a base station managing a cell in a mobile communication system supporting downlink multi-antenna transmission. The processor executes the processes of: receiving beamforming control information fed back from each of a plurality of terminals that are subject to beamforming and that are connected with the cell, and null-steering control information fed back from a terminal subject to null steering; calculating, for each of the plurality of terminals subject to beamforming, assignment priority by which to assign the same radio resource as a radio resource assigned to the terminal subject to null steering, on the basis of reference priority derived from a scheduling algorithm, and matching degree between the null-steering control information and the beamforming control information; and assigning the same radio resource to a terminal subject to beamforming having the highest assignment priority, from among the plurality of terminals subject to beamforming.

### BRIEF DESCRIPTION OF DRAWINGS

FIG. 1 is a configuration diagram of an LTE system according to an embodiment.

FIG. 2 is a block diagram of UE according to the embodiment.

FIG. 3 is a block diagram of eNB according to the embodiment.

FIG. 4 is a protocol stack diagram of a radio interface according to the embodiment.

FIG. 5 is a configuration diagram of a radio frame according to the embodiment.

FIG. 6 is a diagram for describing CB-CoMP according to the embodiment.

FIG. 7 is a diagram for describing CB-CoMP according to the embodiment.

FIG. 8 is a diagram for describing an assignment priority calculation method according to an operation pattern 1 of the embodiment.

FIG. 9 is a diagram for describing an assignment priority calculation method according to an operation pattern 2 of the embodiment.

FIG. 10 is a diagram for describing an assignment priority calculation method according to an operation pattern 3 of the embodiment.

FIG. 11 is a diagram for describing MU-MIMO according to a modification of the embodiment.

FIG. 12 is a diagram for describing MU-MIMO according to the modification of the embodiment.

### DESCRIPTION OF EMBODIMENTS

### Overview of Embodiments

A base station according to embodiments manages a cell in a mobile communication system supporting downlink multi-antenna transmission. The base station comprises a receiver configured to receive beamforming control information fed back from each of a plurality of terminals that are subject to beamforming and that are connected with the cell, and null-steering control information fed back from a terminal subject to null steering; and a controller configured to calculate, for each of the plurality of terminals subject to beamforming, assignment priority by which to assign the same radio resource as a radio resource assigned to the terminal subject to null steering, on the basis of reference priority derived from a scheduling algorithm, and matching degree between the null-steering control information and the beamforming control information. The controller assigns the same radio resource to a terminal subject to beamforming having the highest assignment priority, from among the plurality of terminals subject to beamforming.

In the embodiments, the controller calculates, as the assignment priority, a result obtained by correcting the reference priority in accordance with the matching degree.

In the embodiments, the controller corrects the reference priority so that the assignment priority is relatively high, for a terminal subject to beamforming configured to feed back the beamforming control information that matches the null-steering control information.

In the embodiments, the scheduling algorithm is an algorithm that derives, as the reference priority, a ratio of an instantaneous throughput relative to an average throughput. The controller excludes a terminal subject to beamforming having the reference priority less than a threshold value, from a target to which a radio resource is assigned.

In the embodiments, the receiver receives a plurality of null-steering control information fed back from the terminal subject to null steering. A priority order is associated with each of the plurality of null-steering control information. The controller calculates the assignment priority on the basis of the reference priority, the matching degree, and the priority order.

A communication control method according to the embodiments is used in a mobile communication system supporting downlink multi-antenna transmission. The communication control method comprises the steps of: receiving, by a base station managing a cell, beamforming control information fed back from each of a plurality of terminals that are subject to beamforming and that are connected with the cell, and null-steering control information fed back from a terminal subject to null steering; calculating, by the base station, for each of the plurality of terminals subject to beamforming, assignment priority by which to assign the same radio resource as a radio resource assigned to the terminal subject to null steering, on the basis of reference priority derived from a scheduling algorithm, and matching degree between the null-steering control information and the beamforming control information; and assigning, by the base station, the same radio resource to a terminal subject to beamforming having the highest assignment priority, from among the plurality of terminals subject to beamforming.

A processor according to the embodiments is provided in a base station managing a cell in a mobile communication system supporting downlink multi-antenna transmission. The processor executes the processes of: receiving beamforming control information fed back from each of a plurality of terminals that are subject to beamforming and that are connected with the cell, and null-steering control information fed back from a terminal subject to null steering; calculating, for each of the plurality of terminals subject to beamforming, assignment priority by which to assign the same radio resource as a radio resource assigned to the terminal subject to null steering, on the basis of reference priority derived from a scheduling algorithm, and matching degree between the null-steering control information and the beamforming control information; and assigning the same radio resource to a terminal subject to beamforming having the highest assignment priority, from among the plurality of terminals subject to beamforming.

### Embodiment

An embodiment in which the present invention is applied to an LTE system will be described, below.

(System Configuration)

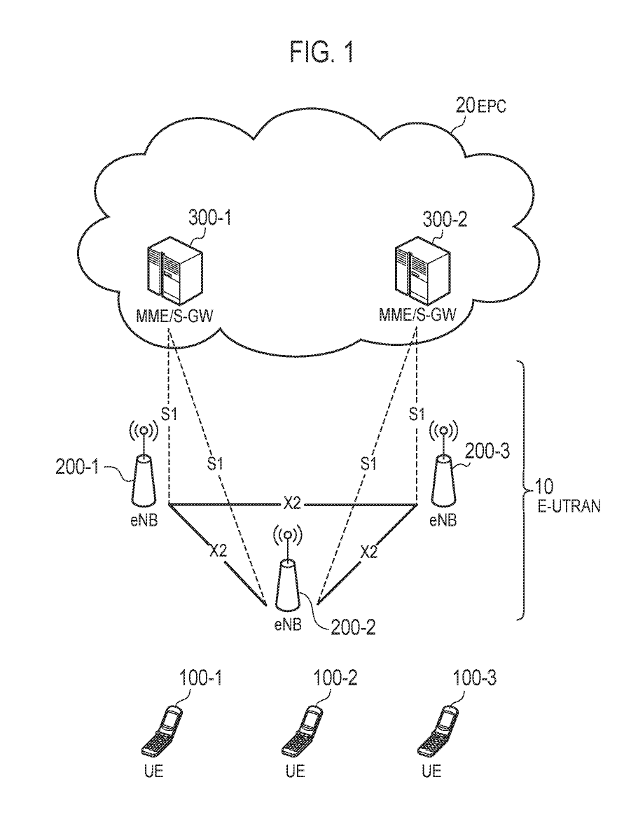

FIG. 1 is a configuration diagram of the LTE system according to the embodiment. As shown in FIG. 1, the LTE system according to the embodiment includes UE (User Equipment) 100, E-UTRAN (Evolved-UMTS Terrestrial Radio Access Network) 10, and EPC (Evolved Packet Core) 20.

The UE 100 corresponds to a user terminal. The UE 100 is a mobile communication device, which performs radio communication with a cell (serving cell) with which a connection is established. The configuration of the UE 100 will be described later.

The E-UTRAN 10 corresponds to a radio access network. The E-UTRAN 10 includes eNB 200 (evolved Node-B). The eNB 200 corresponds to a base station. The eNB 200 is connected mutually via an X2 interface. The configuration of the eNB 200 will be described later.

The eNB 200 manages one or a plurality of cells, and performs radio communication with the UE 100 which establish a connection with a cell of the eNB 200. The eNB 200 has a radio resource management (RRM) function, a routing function of user data, a measurement control function for mobility control and scheduling, and the like. The “cell” is used as a term indicating a smallest unit of a radio communication area, and is also used as a term indicating a function of performing radio communication with the UE 100.

The EPC 20 corresponds to a core network. The EPC 20 includes MME (Mobility Management Entity)/S-GW (Serving-Gateway) 300. The MME performs various types of mobility control and the like for the UE 100. The SGW performs transfer control of the user data. The MME/S-GW 300 is connected to the eNB 200 via an S1 interface.

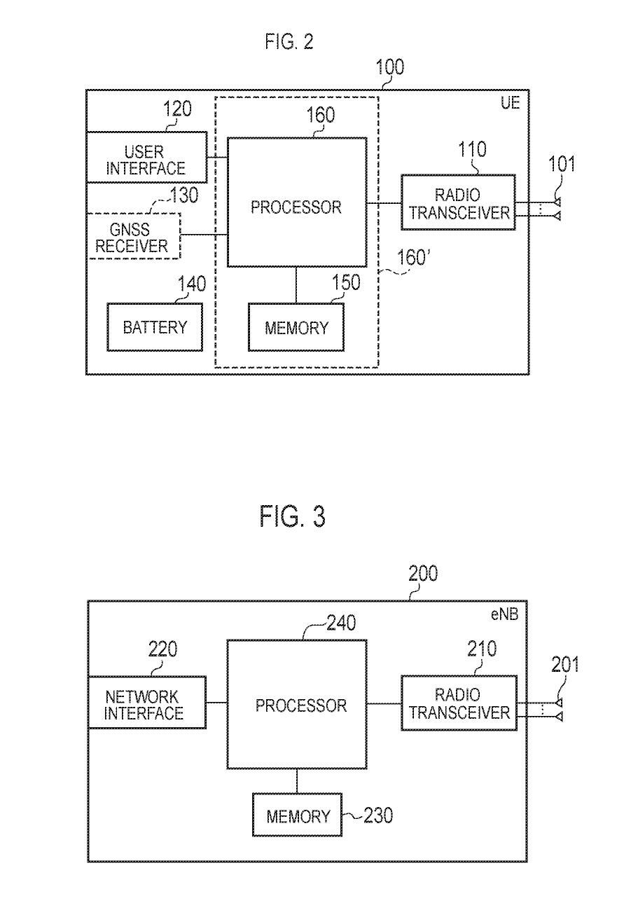

FIG. 2 is a block diagram of the UE 100. As shown in FIG. 2, the UE 100 includes a plurality of antennas 101, a radio transceiver 110, a user interface 120, a GNSS (Global Navigation Satellite System) receiver 130, a battery 140, a memory 150, and a processor 160. The memory 150 and the processor 160 configure a controller. The UE 100 may not necessarily have the GNSS receiver 130. Furthermore, the memory 150 may be integrally formed with the processor 160, and this set (that is, a chip set) may be called a processor 160′.

The plurality of antennas 101 and the radio transceiver 110 are used to transmit and receive a radio signal. The radio transceiver 110 converts a baseband signal (transmission signal) output from the processor 160 into a radio signal, and transmits the radio signal from the plurality of antennas 101. Furthermore, the radio transceiver 110 converts a radio signal received by the plurality of antennas 101 into a baseband signal (reception signal), and outputs the baseband signal to the processor 160.

The user interface 120 is an interface with a user carrying the UE 100, and includes, for example, a display, a microphone, a speaker, various buttons, and the like. The user interface 120 receives an operation from a user and outputs a signal indicating the content of the operation to the processor 160. The GNSS receiver 130 receives a GNSS signal in order to obtain location information indicating a geographical location of the UE 100, and outputs the received signal to the processor 160. The battery 140 accumulates power to be supplied to each block of the UE 100.

The memory 150 stores a program to be executed by the processor 160 and information to be used for processing by the processor 160. The processor 160 includes a baseband processor that performs modulation and demodulation, coding and decoding, and the like on the baseband signal, and a CPU (Central Processing Unit) that performs various types of processes by executing the program stored in the memory 150. The processor 160 may further include a codec that performs encoding and decoding on sound and video signals. The processor 160 executes various types of processes and various communication protocols described later.

FIG. 3 is a block diagram of the eNB 200. As shown in FIG. 3, the eNB 200 includes a plurality of antennas 201, a radio transceiver 210, a network interface 220, a memory 230, and a processor 240. The memory 230 and the processor 240 configure a controller.

The plurality of antennas 201 and the radio transceiver 210 are used to transmit and receive a radio signal. The radio transceiver 210 converts a baseband signal (transmission signal) output from the processor 240 into a radio signal, and transmits the radio signal from the plurality of antennas 201. Furthermore, the radio transceiver 210 converts a radio signal received by the plurality of antennas 201 into a baseband signal (reception signal), and outputs the baseband signal to the processor 240.

The network interface 220 is connected to the neighboring eNB 200 via the X2 interface and is connected to the MME/S-GW 300 via the S1 interface. The network interface 220 is used in communication performed on the X2 interface and communication performed on the S1 interface.

The memory 230 stores a program to be executed by the processor 240 and information to be used for processing by the processor 240. The processor 240 includes a baseband processor that performs modulation and demodulation, coding and decoding, and the like on the baseband signal, and a CPU that performs various types of processes by executing the program stored in the memory 230. The processor 240 executes various types of processes and various communication protocols described later.

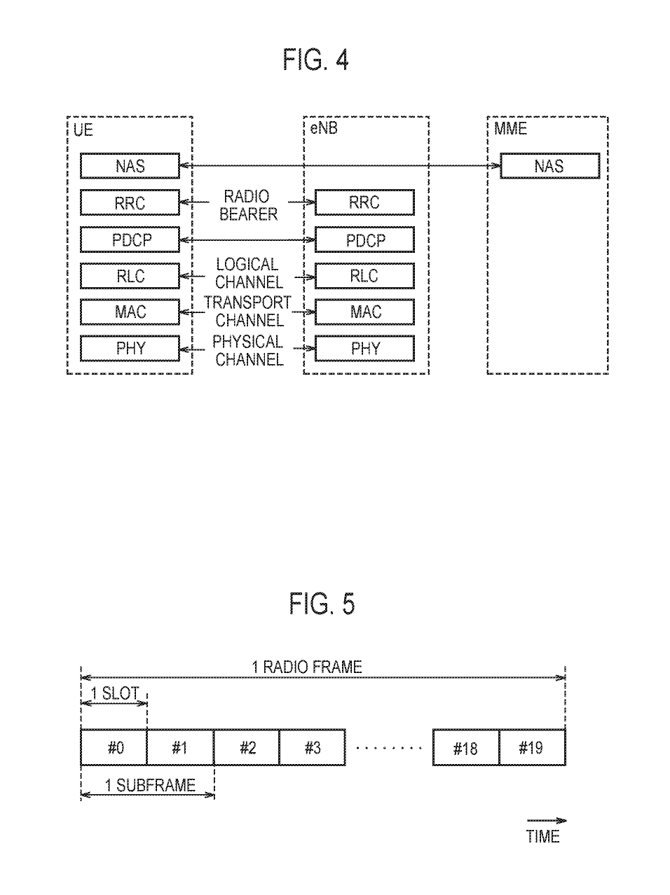

FIG. 4 is a protocol stack diagram of a radio interface in the LTE system. As shown in FIG. 4, the radio interface protocol is classified into a first layer to a third layer of an OSI reference model, such that the first layer is a physical (PHY) layer. The second layer includes a MAC (Media Access Control) layer, an RLC (Radio Link Control) layer, and a PDCP (Packet Data Convergence Protocol) layer. The third layer includes an RRC (Radio Resource Control) layer.

The physical layer performs coding and decoding, modulation and demodulation, antenna mapping and demapping, and resource mapping and demapping. The physical layer of the eNB 200 performs the downlink multi-antenna transmission by applying a precoder matrix (transmission antenna weight) and a rank (signal sequence number). The downlink multi-antenna transmission according to the embodiment will be described in detail, later. Between the physical layer of the UE 100 and the physical layer of the eNB 200, user data and control signals are transmitted via a physical channel.

The MAC layer performs priority control of data, and a retransmission process and the like by a hybrid ARQ (HARQ). Between the MAC layer of the UE 100 and the MAC layer of the eNB 200, user data and control signals are transmitted via a transport channel. The MAC layer of the eNB 200 includes a scheduler for determining a transport format (a transport block size and a modulation and coding scheme) of an uplink and a downlink, and a resource block to be assigned to the UE 100.

The RLC layer transmits data to an RLC layer of a reception side by using the functions of the MAC layer and the physical layer. Between the RLC layer of the UE 100 and the RLC layer of the eNB 200, user data and control signals are transmitted via a logical channel.

The PDCP layer performs header compression and decompression, and encryption and decryption.

The RRC layer is defined only in a control plane that handles control signals. Between the RRC layer of the UE 100 and the RRC layer of the eNB 200, a control signal (RRC message) for various types of settings is transmitted. The RRC layer controls the logical channel, the transport channel, and the physical channel according to the establishment, re-establishment, and release of a radio bearer. When a connection (RRC connection) is established between the RRC of the UE 100 and the RRC of the eNB 200, the UE 100 is in a connected state (RRC connected state), and when the connection is not established, the UE 100 is in an idle state (RRC idle state).

An NAS (Non-Access Stratum) layer positioned above the RRC layer performs session management, mobility management, and the like.

FIG. 5 is a configuration diagram of a radio frame used in the LTE system. In the LTE system, OFDMA (Orthogonal Frequency Division Multiplexing Access) is applied to a downlink, and SC-FDMA (Single Carrier Frequency Division Multiple Access) is applied to an uplink, respectively.

As shown in FIG. 5, a radio frame is configured by 10 subframes arranged in a time direction. Each subframe is configured by two slots arranged in the time direction. Each subframe has a length of 1 ms and each slot has a length of 0.5 ms. Each subframe includes a plurality of resource blocks (RBs) in a frequency direction, and a plurality of symbols in the time direction. Each of the resource blocks includes a plurality of subcarriers in the frequency direction. Among radio resources assigned to the UE 100, a frequency resource can be specified by a resource block and a time resource can be specified by a subframe (or a slot).

In the downlink, an interval of several symbols at the head of each subframe is a region used as a physical downlink control channel (PDCCH) for mainly transmitting a control signal. Furthermore, the remaining portion of each subframe is a region available as a physical downlink shared channel (PDSCH) for mainly transmitting user data.

In the uplink, both ends in the frequency direction of each subframe are regions used as a physical uplink control channel (PUCCH) for mainly transmitting a control signal. The remaining portion in each subframe is a region available as a physical uplink shared channel (PUSCH) for mainly transmitting user data.

(CB-CoMP)

The LTE system according to the present embodiment supports CB-CoMP which is a mode of the downlink multi-antenna transmission. In the CB-CoMP, a plurality of eNBs 200 work together to perform the beamforming and the null steering.

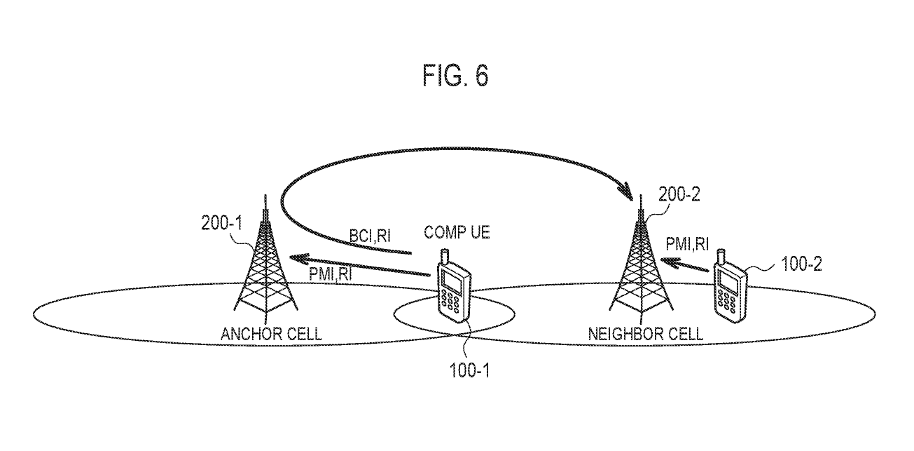

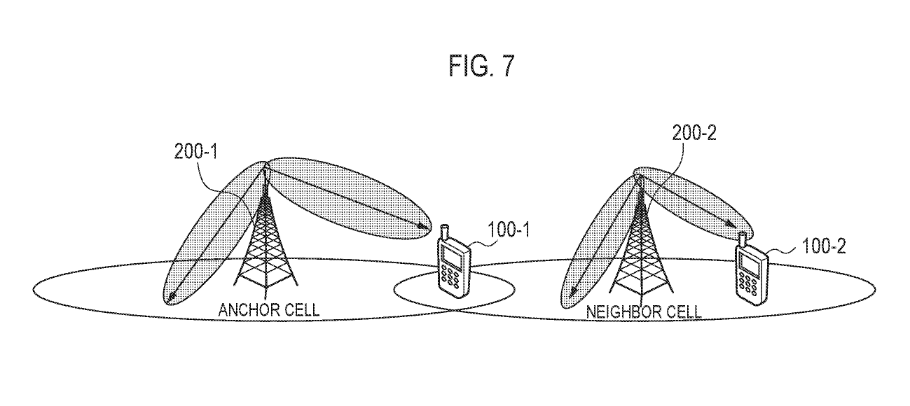

FIG. 6 and FIG. 7 are diagrams for describing the CB-CoMP. As shown in FIG. 6, eNB 200-1 and eNB 200-2 manage cells adjacent to each other. Further, the cell of the eNB 200-1 and the cell of the eNB 200-2 belong to the same frequency.

The UE 100-1 is in a state of establishing connection with a cell of the eNB 200-1 (connected state). That is, the UE 100-1 uses, as the serving cell, the cell of the eNB 200-1 to perform communication.

On the other hand, the UE 100-2 is in a state of establishing connection with a cell of the eNB 200-2 (connected state). That is, the UE 100-2 uses, as the serving cell, the cell of the eNB 200-2 to perform communication. In FIG. 6, only one UE 100-2 is shown which establishes the connection with the cell of the eNB 200-2; however, in a real environment, a plurality of UEs 100-2 establish the connection with the cell of the eNB 200-2.

The UE 100-1 is located at a boundary area of the cell of the eNB 200-1 and the cell of the eNB 200-2. In this case, the UE 100-1 is influenced by interference from the cell of the eNB 200-2. When the CB-CoMP is applied to the UE 100-1, it is possible to suppress the interference received in the UE 100-1.

A communication procedure of the CB-CoMP when the CB-CoMP is applied to the UE 100-1 will be described, below. It is noted that the UE 100-1 to which the CB-CoMP is applied may be called a “CoMP UE”. That is, the UE 100-1 corresponds to a terminal subject to null steering. The serving cell of the UE 100-1 (CoMP UE) may be called an “anchor cell”.

Each of the UE 100-1 and the UE 100-2 feeds beamforming control information for directing a beam to the UEs 100-1 and 100-2, back to the serving cell, on the basis of a reference signal received from the serving cell, for example. In the embodiment, the beamforming control information includes a precoder matrix indicator (PMI) and a rank indicator (RI). The PMI is an indicator indicating a precoder matrix (transmission antenna weight) recommended to the serving cell. The RI is an indicator indicating a rank (signal sequence number) recommended to the serving cell. Each of the UE 100-1 and the UE 100-2, which holds a table (code book) in which the precoder matrix and the indicator are associated, selects the precoder matrix that improves communication quality of a desired wave, and feeds back, as the PMI, the indicator corresponding to the selected precoder matrix.

The UE 100-1 further feeds null-steering control information for directing a null to the UE 100-1, back to the serving cell, on the basis of a reference signal received from a neighboring cell, for example. In the embodiment, the null-steering control information includes BCI (Best Companion PMI) and the RI. The BCI is an indicator indicating a precoder matrix (transmission antenna weight) recommended to the neighboring cell. The UE 100-1, which holds a table (code book) in which the precoder matrix and the indicator are associated, selects the precoder matrix that reduces a reception level of an interference wave or reduces influence to a desired wave, and feeds back, as the BCI, the indicator corresponding to the selected precoder matrix.

The eNB 200-1 transfers the null-steering control information (BCI, RI) fed back from the UE 100-1, to the eNB 200-2.

The eNB 200-2 receives the beamforming control information (PMI, RI) fed back from each of the plurality of UEs 100-2 connected with a cell of the eNB 200-2 and the null-steering control information (BCI, RI) fed back from the UE 100-1 connected with the neighboring cell. Then, the eNB 200-2 selects the UE 100-2 that feeds back the beamforming control information that matches the null-steering control information, as a pair UE (pair terminal) that forms a pair with the UE 100-1. In the embodiment, the “beamforming control information that matches the null-steering control information” is beamforming control information that includes a combination of the PMI and the RI that matches a combination of the BCI and the RI included in the null-steering control information.

When selecting the pair UE (UE 100-2), the eNB 200-2 assigns the same radio resource as the radio resource assigned to the UE 100-1, to the pair UE. Then, the eNB 200-2 applies the beamforming control information (PMI, RI) fed back from the pair UE, and performs a transmission to the pair UE. As a result, as shown in FIG. 7, the eNB 200-2 is capable of performing a transmission to the pair UE by directing a beam to the pair UE while directing a null to the UE 100-1.

(Operation of eNB 200-2)

Next, the operation of the eNB 200-2 according to the embodiment will be described.

(1) Operation Overview

As described above, the eNB 200-2 selects, as the pair UE that forms a pair with the UE 100-1, the UE 100-2 that feeds back the beamforming control information (PMI, RI) that matches the null-steering control information (BCI, RI) fed back from the UE 100-1. Here, the UE 100-1 corresponds to the terminal subject to null steering and the UE 100-2 corresponds to the terminal subject to beamforming.

However, when there is no UE 100-2 that feeds back the beamforming control information that matches the null-steering control information, the eNB 200-2 is not capable of selecting the pair UE that forms a pair with the UE 100-1. In this case, it may be possible that the eNB 200-2 does not use the radio resource assigned to the UE 100-1 or randomly selects a pair terminal. However, there is a problem that in the former case, usage efficiency of the radio resource is decreased, and in the latter case, interference to the UE 100-1 is increased.

Therefore, in the embodiment, the eNB 200-2 calculates, with respect to each of the plurality of UEs 100-2, assignment priority by which to assign the same radio resource as the radio resource assigned to the UE 100-1, on the basis of reference priority derived from a scheduling algorithm, and matching degree between the null-steering control information and the beamforming control information. Then, the eNB 200-2 assigns the same radio resource as the radio resource assigned to the UE 100-1, to the UE 100-2 having the highest assignment priority, from among the plurality of UEs 100-2.

Thus, when the assignment priority is calculated on the basis of the reference priority derived from the scheduling algorithm and the matching degree between the null-steering control information and the beamforming control information, even when there is no UE 100-2 that feeds back the beamforming control information that matches the null-steering control information, it is possible to appropriately select the pair UE that forms a pair with the UE 100-1.

In the embodiment, the eNB 200-2 calculates, as the assignment priority, a result obtained by correcting the reference priority derived from the scheduling algorithm in accordance with the matching degree between the null-steering control information and the beamforming control information. For example, the eNB 200-2 corrects the reference priority for the UE 100-2 that feeds back the beamforming control information that matches the null-steering control information so that the assignment priority is relatively high.

(2) Operation Specific Example

An operation specific example of the eNB 200-2 according to the embodiment will be described, below.

(2.1) Operation Pattern 1

The radio transceiver 210 of the eNB 200-2 receives the beamforming control information (PMI, RI) fed back from each of the plurality of UEs 100-2 connected with a cell of the eNB 200-2. Further, the network interface 220 of the eNB 200-2 receives, by way of the eNB 200-1, the null-steering control information (BCI, RI) fed back from the UE 100-1 (CoMP UE) connected with the neighboring cell. In the embodiment, the radio transceiver 210 and the network interface 220 configure a receiver configured to receive the beamforming control information and the null-steering control information.

The processor 240 of the eNB 200-2 calculates the assignment priority about the same radio resource as the radio resource assigned to the UE 100-1, on the basis of the beamforming control information received by the radio transceiver 210 and the null-steering control information received by the network interface 220, for example.

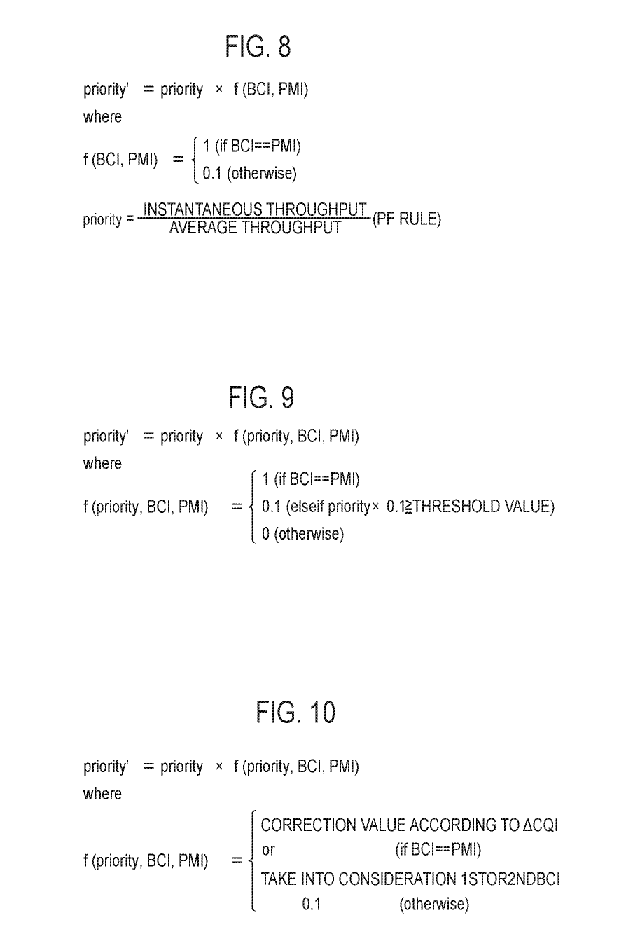

FIG. 8 is a diagram for describing an assignment priority calculation method according to an operation pattern 1.

As shown in FIG. 8, the processor 240 calculates a result obtained by correcting “priority” that is the reference priority derived from the scheduling algorithm in accordance with “f(BCI, PMI)” indicating the matching degree between the null-steering control information and the beamforming control information, as assignment priority “priority’” about the same radio resource as the radio resource assigned to the UE 100-1. The processor 240 calculates the assignment priority “priority’” for each of the plurality of UEs 100-2, and assigns the same radio resource as the radio resource assigned to the UE 100-1, to the UE 100-2 having the highest assignment priority.

In the operation pattern 1, the scheduling algorithm is an algorithm that derives, as the reference priority, a ratio of an instantaneous throughput relative to an average throughput. Such an algorithm is termed as a proportional fairness (PF) rule. However, the reference priority “priority” may be derived by using not only the proportional fairness rule but also another scheduling algorithm. “f(BCI, PMI)” is “1” when the null-steering control information and the beamforming control information match, and “f(BCI, PMI)” is “0.1” when the null-steering control information and the beamforming control information do not match. As a result, for the UE 100-2 that feeds back the beamforming control information that matches the null-steering control information, the reference priority “priority” is corrected so that the assignment priority “priority’” is relatively high. On the other hand, for the UE 100-2 that feeds back the beamforming control information that does not match the null-steering control information, the reference priority “priority” is corrected so that the assignment priority “priority’” is relatively low.

(2.2) Operation Pattern 2

FIG. 9 is a diagram for describing an assignment priority calculation method according to an operation pattern 2 of the embodiment. Here, description proceeds with a focus on a difference from the operation pattern 1.

As shown in FIG. 9, the feature that a result obtained by correcting “priority” that is the reference priority derived from the scheduling algorithm in accordance with “f(BCI, PMI)” indicating the matching degree between the null-steering control information and the beamforming control information is calculated as the assignment priority “priority’” is in much the same way as in the operation pattern 1.

On the other hand, in the operation pattern 2, the processor 240 excludes the UE 100-2 having the reference priority “priority” less than a threshold value from a target to which the radio resource is assigned. Specifically, for the UE 100-2 having the reference priority “priority” less than the threshold value, “f(BCI, PMI)” is set to “0”, and the assignment priority “priority’” is set to “0”. When the proportional fairness rule is used as the scheduling algorithm, when the reference priority “priority” is low, this means that throughput improvement effect is low. Thus, in the operation pattern 2, the UE 100-2 where it is not possible to expect improvement in throughput is rendered impossible to assign the radio resource.

(2.3) Operation Pattern 3

FIG. 10 is a diagram for describing an assignment priority calculation method according to an operation pattern 3. Here, description proceeds with a focus on a difference from the operation pattern 1.

As shown in FIG. 10, the feature that a result obtained by correcting “priority” that is the reference priority derived from the scheduling algorithm in accordance with “f(BCI, PMI)” indicating the matching degree between the null-steering control information and the beamforming control information is calculated as the assignment priority “priority’” is in much the same way as in the operation pattern 1.

On the other hand, in the operation pattern 3, the processor 240, when the null-steering control information and the beamforming control information match, adjusts “f(BCI, PMI)” in accordance with “ΔCQI” indicating improvement degree of reception quality in the UE 100-1, or a priority order of the null-steering control information.

“ΔCQI” is information fed back from the UE 100-1. “ΔCQI” may be included in the null-steering control information. The UE 100-1 calculates, as the “ΔCQI”, the difference between a CQI (Channel Quality Indicator) corresponding to a reception quality when the null-steering control information is not adopted and a CQI (Channel Quality Indicator) corresponding to a reception quality when the null-steering control information is adopted, and feeds back the “ΔCQI”. For example, the processor 240 set the value of the “f(BCI, PMI)” such as the larger the “ΔCQI” is the larger the value of the “f(BCI, PMI)” is. On the other hand, the processor 240 set the value of the “f(BCI, PMI)” such as the smaller the “ΔCQI” is the smaller the value of the “f(BCI, PMI)” is.

The priority order of the null-steering control information is information indicating, when the UE 100-1 feeds back a plurality of null-steering control information, a priority order of the plurality of null-steering control information. The UE 100-1 sets a null-steering control information of which the interference level is the lowest as a first priority order and sets a null-steering control information of which the interference level is the next lowest as a second priority order, and feeds back them. For example, the processor 240 sets the value of the “f(BCI, PMI)” about the first priority order null-steering control information lager than the value of the “f(BCI, PMI)” about the second priority order null-steering control information.

### Summary of Embodiment

As described above, the eNB 200-2 calculates the assignment priority on the basis of reference priority derived from the scheduling algorithm, and the matching degree between the null-steering control information and the beamforming control information. As a result, even when there is no UE 100-2 that feeds back the beamforming control information that matches the null-steering control information, it is possible to appropriately select the pair UE that forms a pair with the UE 100-1 from the plurality of UEs 100-2.

### Modification of Embodiment

In the above-described embodiment, an example is described where the present invention is applied to the CB-CoMP which is a mode of the downlink multi-antenna transmission; however, the present invention may be applied to MU (Multi-User)-MIMO (Multiple-Input and Multiple-Output) which is another mode of the downlink multi-antenna transmission. In a modification of the embodiment, a case will be described where the present invention is applied to the MU-MIMO.

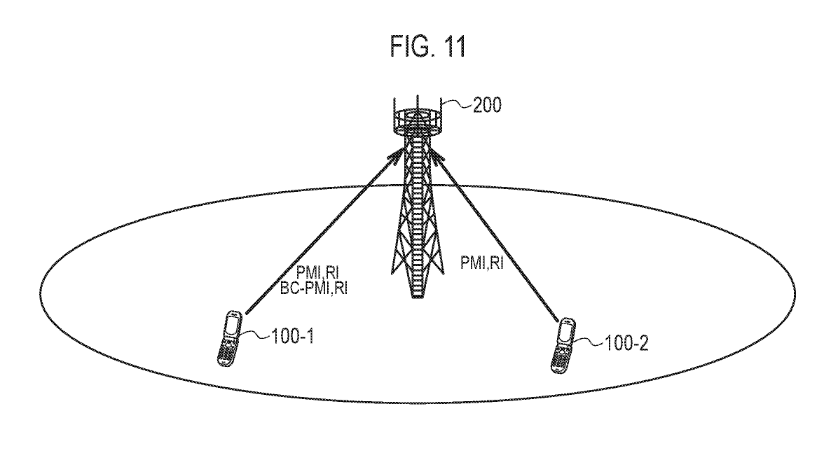

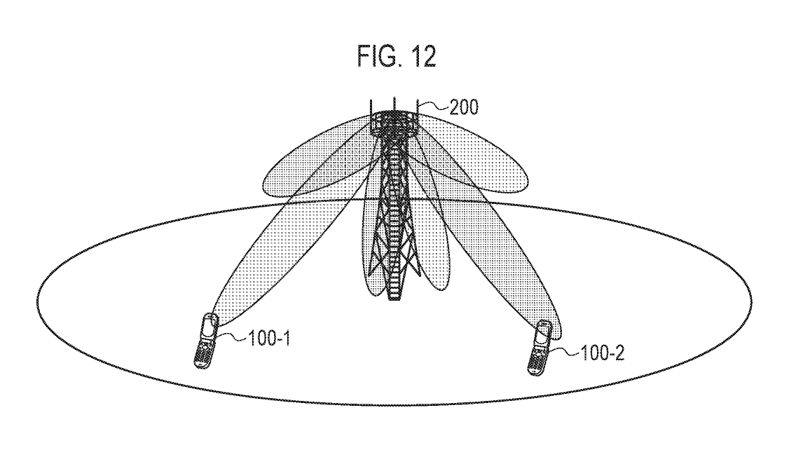

FIG. 11 and FIG. 12 are diagrams for describing the MU-MIMO. As shown in FIG. 11, each of the UE 100-1 and the UE 100-2 is in a state of establishing connection with a cell of the eNB 200 (connected state). That is, each of the UE 100-1 and the UE 100-2 uses, as a serving cell, the cell of the eNB 200 to perform communication. In FIG. 11, only two UEs 100 are shown which establish the connection with the cell of the eNB 200; however, in a real environment, three or more UEs 100 establish the connection with the cell of the eNB 200.

A communication procedure of the MU-MIMO when the MU-MIMO is applied to the UE 100-1 will be described, below. Here, the UE 100-1 corresponds to the terminal subject to null steering and the UE 100-2 corresponds to the terminal subject to beamforming. It is noted that a duplicated description with the above-described embodiment will be omitted.

Each of the UE 100-1 and the UE 100-2 feeds the beamforming control information for directing a beam to the UEs 100-1 and 100-2, back to the serving cell, on the basis of the reference signal received from the serving cell, for example. The beamforming control information includes the PMI and the RI.

The UE 100-1 further feeds the null-steering control information for directing a null to the UE 100-1, back to the serving cell, on the basis of the reference signal received from the serving cell, for example. The null-steering control information includes the BCI (Best Companion PMI) and the RI.

The eNB 200 receives the beamforming control information (PMI, RI) fed back from each of the plurality of UEs 100-2 connected with a cell of the eNB 200 and the null steering control information (BCI, RI) fed back from the UE 100-1 connected with a cell of the eNB 200. Then, the eNB 200 calculates an assignment priority by any of the assignment priority calculation methods of the operation pattern 1-3 according to the embodiment described above and selects a pair UE (pair terminal) that forms a pair with the UE 100-1.

When selecting the pair UE (UE 100-2), the eNB 200 assigns the same radio resource as the radio resource assigned to the UE 100-1, to the pair UE. Then, the eNB 200 applies the beamforming control information (PMI, RI) fed back from the pair UE, and performs a transmission to the pair UE. As a result, as shown in FIG. 12, the eNB 200 is capable of performing a transmission to the pair UE by directing a beam to the pair UE while directing a null to the UE 100-1.

### Other Embodiments

“ΔCQI” according to the above-described embodiment may be included in each of the null-steering control information and the beamforming control information. In this case, the eNB 200 (eNB 200-2) that receives the null-steering control information and the beamforming control information may select, taking into consideration “ΔCQI”, a pair UE so that system throughput is maximized.

In the above-described embodiment, the null-steering control information transmitted by the UE 100-1 is indirectly fed back to the eNB 200-2 via the eNB 200-1; however, the null-steering control information may be directly fed back to the eNB 200-2 without passing through the eNB 200-1.

In the above-described embodiment and modification thereof, the BCI is described as an example of the null-steering control information; however, WCI (Worst Companion PMI) may be used instead of the BCI. The WCI is an indicator indicating the precoder matrix in which an interference level from an interference source is high. The eNB 200 receives the beamforming control information (PMI, RI) fed back from each of the plurality of UEs 100-2 and the null-steering control information (WCI, RI) fed back from the UE 100-1. Then, the eNB 200 selects the UE 100-2 that feeds back the beamforming control information that matches the null-steering control information, as a pair UE (pair terminal) that forms a pair with the UE 100-1. In this case, the beamforming control information that matches the null-steering control information is beamforming control information that includes the PMI that does not match the WCI included in the null-steering control information, or that includes the RI that does not match the RI included in the null-steering control information. Alternatively, when a combination of the PMI and the RI where the interference is the largest is fed back as the null-steering control information (WCI and RI), it may be possible that the beamforming control information matches the null-steering control information in a case of any combination other than the combination described above.

In the above-described embodiment and modification thereof, the beamforming control information and the null-steering control information include the RI; however, the beamforming control information and the null-steering control information may not necessarily include the RI.

In the above-described embodiments, as one example of the cellular communication system, the LTE system is described; however, the present invention is not limited to the LTE system, and the present invention may be applied to systems other than the LTE system.

In addition, the entire content of Japanese Patent Application No. 2013-134378 (filed on Jun. 26, 2013) is incorporated in the present specification by reference.

### INDUSTRIAL APPLICABILITY

According to the present invention, it is possible to provide a base station capable of appropriately selecting a pair terminal that forms a pair with a terminal subject to null steering, from among a plurality of terminals subject to beamforming, a communication control method therefor, and a processor therefor.

1. A base station managing a cell in a mobile communication system supporting downlink multi-antenna transmission, comprising:
a receiver configured to receive beamforming control information fed back from each of a plurality of terminals that are subject to beamforming and that are connected with the cell, and null-steering control information fed back from a terminal subject to null steering; and
a controller configured to calculate, for each of the plurality of terminals subject to beamforming, assignment priority for assigning the same radio resource as a radio resource assigned to the terminal subject to null steering, on the basis of reference priority derived from a scheduling algorithm, and matching degree between the null-steering control information and the beamforming control information, wherein
the controller assigns the same radio resource to a terminal subject to beamforming having the highest assignment priority, from among the plurality of terminals subject to beamforming.

2. The base station according to claim 1, wherein
the controller calculates, as the assignment priority, a result obtained by correcting the reference priority in accordance with the matching degree.

3. The base station according to claim 2, wherein
the controller corrects the reference priority so that the assignment priority is relatively high, for a terminal subject to beamforming configured to feed back the beamforming control information that matches the null-steering control information.

4. The base station according to claim 1, wherein
the scheduling algorithm is an algorithm that derives, as the reference priority, a ratio of an instantaneous throughput relative to an average throughput, and
the controller excludes a terminal subject to beamforming having the reference priority less than a threshold value, from a target to which a radio resource is assigned.

5. The base station according to claim 1, wherein
the receiver receives a plurality of null-steering control information fed back from the terminal subject to null steering,
a priority order is associated with each of the plurality of null-steering control information, and
the controller calculates the assignment priority on the basis of the reference priority, the matching degree, and the priority order.

6. A method used by a base station managing a cell in a mobile communication system supporting downlink multi-antenna transmission, comprising the steps of:
receiving, beamforming control information fed back from each of a plurality of terminals that are subject to beamforming and that are connected with the cell, and null-steering control information fed back from a terminal subject to null steering;
calculating for each of the plurality of terminals subject to beamforming, assignment priority for assigning the same radio resource as a radio resource assigned to the terminal subject to null steering, on the basis of reference priority derived from a scheduling algorithm, and matching degree between the null-steering control information and the beamforming control information; and
assigning the same radio resource to a terminal subject to beamforming having the highest assignment priority, from among the plurality of terminals subject to beamforming.

7. A processor for controlling a base station managing a cell in a mobile communication system supporting downlink multi-antenna transmission, wherein the processor executes the processes of:
receiving beamforming control information fed back from each of a plurality of terminals that are subject to beamforming and that are connected with the cell, and null-steering control information fed back from a terminal subject to null steering;
calculating, for each of the plurality of terminals subject to beamforming, assignment priority for assigning the same radio resource as a radio resource assigned to the terminal subject to null steering, on the basis of reference priority derived from a scheduling algorithm, and matching degree between the null-steering control information and the beamforming control information; and
assigning the same radio resource to a terminal subject to beamforming having the highest assignment priority, from among the plurality of terminals subject to beamforming.
